(19) United States
(12) Patent Application Publication
(10) Pub. No.: US 2022/0411902 A1
(43) Pub. Date: Dec. 29, 2022

(54) RARE-EARTH HIGH ENTROPY ALLOYS AND TRANSITION METAL HIGH ENTROPY ALLOYS AS BUILDING BLOCKS FOR THE SYNTHESIS OF NEW MAGNETIC PHASES FOR PERMANENT MAGNETS

(71) Applicant: NIARCHOS, Dimitrios, Athens (GR)

(72) Inventor: Dimitrios NIARCHOS, Athens (GR)

(21) Appl. No.: 17/764,861

(22) PCT Filed: Sep. 30, 2019
(86) PCT No.: PCT/EP2019/076449

§ 371 Date: Mar. 29, 2022

(51) Int. Cl. C22C 28/00; H01F 1/057; H01F 1/055

(52) U.S. Cl. CPC C22C 28/00; H01F 1/0571; H01F 1/0551

(57) ABSTRACT

The invention relates to high entropy alloy of rare earth elements (RE-HEAs) including at least four and up to twelve elements selected form rare earth elements R₁, R₂, R₃, R₄, R₅, R₆, R₇, R₈, R₉, R₁₀, R₁₁, R₁₂, which rare earth elements R₁ to R₁₂ each represents one of elements 57 to 60, 62 to 70, 39 and 40 of the periodic system and to high entropy alloy of transition elements (TM-HEAs) including at least 3 and up to 12 elements selected from transitional elements TM₁, TM₂, TM₃, TM₄, TM₅, TM₆, TM₇, TM₈, TM₉, TM₁₀, TM₁₁, TM₁₂, which transitional elements TM₁ to TM₁₂ each represent at least one of elements 21 to 30, 41 to 48 and 72 to 79 of the periodic system. Such RE-HEAs and/or TM-HEAs can be used as building blocks in magnetic high entropy composite alloys, e.g. of the type (RE-HEAs)ₓ(TM-HEAs)_{y}T_{z}, for the manufacture of magnetic devices and permanent magnets.

The technical field to which the invention refers is that of high entropy magnetic alloys, simple and complex, based on the periodic table of chemical elements, with exceptional magnetic and mechanical properties, as well as their use as new building blocks for the replacement of rare earth elements and cobalt in magnetic phases and the technical field of permanent magnets made with them.

As used here, the term “rare earth elements” includes lanthanide elements that have atomic numbers from 57 to 70, except Pm with atomic number 61, as well as yttrium with atomic number 39 and zirconium with atomic number 40, which are usually found in rare earth ores and have similar chemical properties. The term “rare earth elements heavy element” (HRE) is used here to refer to these elements of lanthanide series which have atomic numbers from 63 to 71, and the term “rare earth elements light element” (LHR) data with atomic numbers 57 to 62, except Pm with atomic number 61.

As the term “transition elements” is used here, it is understood to include elements belonging to the Periodic System from groups 3 to 12 with atomic numbers 21 to 30, 41 to 48 and 72 to 79. The most representative are the elements with atomic numbers such manganese (25), iron (26), cobalt (27) and nickel (28) and various alloys containing one or more of these metals. Added elements for the creation of magnetic alloys are also considered boron (5), aluminum (13), gallium (31) and indium (49).

Ferromagnetic metals and permanent magnets have the characteristic status of magnetic hysteresis. Magnetic hysteresis is the property of magnetic bodies in which their magnetic induction depends not only on the intensity of the magnetic field but also on the previous magnetic state (hysteresis loop). Points in the hysterisis loop of particular interest to this invention are within the second quadrant, or ‘demagnetizing curve’, since most apparatuses using permanent magnets operate under the influence of a demagnetizing field and are given in FIG. 1.

The basis for the manufacture of permanent magnets is the existence of magnetic alloys with interesting properties, such as (a) a crystalline structure with a symmetry lower than cubic, e.g. tetragonal, (b) high magnetocrystalline anisotropy (>1*107 J/m3) and (c) high Curie point (the temperature where magnetization becomes zero in a magnetic alloy) which must be greater than or equal to >50% of the predicted maximum working temperature of the permanent magnet. Since the magnetic alloy has high magnetocrystalline anisotropy, another very interesting property is the coercive field Hc defined as the value of the magnetic field that the magnetization is reversed as shown in FIG. 1.

Permanent magnets (permanent ferromagnetism materials) based on the above magnetic compounds have found huge applications in energy generation and conversion, micro-large electrical devices, health and the environment, with a market of more than $20B for 2020. There are many applications for magnets, such as headphones in speakers, electric motors, generators, counters, and multiform scientific devices. Research in the sector has usually been directed towards the development of permanent magnets with materials that have constantly better properties, especially in recent years, where the reduction in size of devices based on permanent magnets has become the main prerequisite for expanding their applications, such as for computer equipment, mobile phones, headphones and many other devices. Today, there are three large families of permanent magnets produced by sintering and powder metallurgy, by alloys of rare earth metals and transition elements, as described above.

The first category is the samarium-cobalt type (Samarium-Cobalt) with stoichiometry (1:5 and 2:17):

Most popular is an alloy containing samarium and cobalt with a chemical formula of SmCo5 (1:5) FIG. 2, or Sm(Co(balance)FexCu0.1Zr0.03)7.5-8.5 (x=0.09-0.21), developed in the late 1960s and early 1970s. These magnets usually contain small amounts of other elements to help to modify their magnetic properties mentioned above. Samarium-cobalt magnets, however, are quite expensive, due to the relative scarcity—mainly of samarium—and the high price of cobalt. This factor has reduced the usefulness of magnets in large volume applications, such as electric motors, and research has been encouraged to develop permanent magnets with materials that are more abundant than the metals of rare earth metals and cobalt, which are less costly. Samarium-cobalt magnets are the only ones that can be used at high temperatures of up to 500° C., the Curie point is greater than 750° C., making them preferred, although not so large in energy product, ranging from 16-33 MGOe (128-264 KJ/m3 close to the theoretical upper limit of 34 MGOe or 270 KJ/m3 (1 MGOe˜7.95 KJ/m3).

The second family of permanent magnets is type Nd2Fe14B:

Research efforts by M. Sagawa in 1984 resulted in the discovery of new magnetic alloys containing neodymium that is more abundant in ores containing rare earth elements than samarium, iron that is far cheaper than cobalt and boron in various proportions (see J. Appl. Phys. Vol 55, pages 2083-2087 (1984)). The chemical formula for the new magnetic materials is R2Fe14B (where R is a light rare earth, e.g. neodymium (Nd), praseodymium (Pr) or cerium (Ce) (see A L Robinson, Science, Vol. 223, pages 920-922 (1984). Further guidance on the production of rare earth-iron-boron magnets is disclosed by M. Sagawa, S. Fujimura, and Y. Matsuura in European Patent Applications No. 83 106 573.5 and 83 107 351.5, which were filed on 5 Jul. 1983 and 26 Jul. 1983, respectively. The energy product for neodymium-iron-boron magnets is of the order of 52 MGOe or approximately 420 KJ/m3, which makes these magnets the strongest to date. Due to the low Curie point of the magnetic phase Nd2Fe14B, which is approximately 310° C., the use of these magnets is limited to temperatures up to 130-150° C. Addition of Heavy Rare Earth (HRE) like Dysprosium (Dy) or Terbium (Tb) improves both the energy product and the operating temperature up to 180-200° C.

The third category of magnets is type RFe12-xTx:

This category was discovered at the end of the 1980s by Buschow (IEEE, Trans. Magn. MAG-24 (1988), 1611) and by Ohashi ((IEEE). Trans. Magn. MAG-23 (1987) 3101), the main characteristic being the lowest percentage of Light Rare Earth (LRE) elements (LRE, e.g. Nd, Pr, Sm) at approximately 7.8%, a Curie temperature at approximately 300° C., high magnetization and relatively high magnetic anisotropy. Although the phase has been known since the end of the 1980s, it has only recently been possible to manufacture permanent magnets with interesting properties, as can be seen from the patent application US2017/0178772 A1, 22 Jun. 2017 with a beneficiary of Toyota. The above phase becomes more attractive for applications as all magnetic properties are improved by the nitrogen absorption in the crystalline lattice, as recently demonstrated by Hirayama (Scr. Mater. 95(2015) 70). Since nitrogen escapes from an alloy at temperatures above approximately 500° C., new techniques are required for the sintering of magnetic powders below 500° C., or new direct casting techniques for permanent magnets. Magnets of this category, although theoretically they have a higher energy product than the previous magnets, are expected to cover the intermediate category with an energy product of 100-250 KJ/m3 due to a lower magnetocrystalline anisotropy.

All three categories reported, in addition to their respective costs, energy product and maximum temperature that can be used, have poor mechanical properties, and due to the way they are made from metal powders of appropriate magnetic alloys and by sintering, they are fragile and require great care and attention in their use.

In addition, there are:

High Entropy Alloys (HEAs):

A significant interest has been shown in recent years in exploring new alloys using the concept of high entropy alloy design (HEA). High entropy alloys (HEAs) have been defined since 2004 (Yeh, Advance Engineering, Vol 6, Issue 5, 299-303, 2004) as alloys having at least four main elements in equimolar concentration, which each has an individual rate between 5% and 35% depending on the number of elements used and are shown in FIG. 3.

The HEA alloy design approach has broadened the scope of composition design and new types of HEAs and high entropy materials have been developed, such as high entropy hyperalloys, high density entropy alloys, large metal long entropy glasses, high entropy carbides, high entropy nitrides, high entropy oxides high entropy composite materials.

High entropy alloys (HEAs) currently have a high research interest in material science and engineering. Unlike conventional alloys, which contain one and usually two elements of base, HEAs include multiple key elements in equimolar concentration, with the possible number of HEA compositions expanding significantly more than conventional alloys. Most importantly, these HEAs can be constructed and processed using similar procedures as conventional materials. Conventional material characterization techniques for HEA may also be used. Combinations of compositions in the field of HEAs and treatment pathways can potentially lead to a wide range of novel micro-structures and properties. Many preliminary studies have demonstrated their potential to replace conventional materials for industrial applications.

The main characteristics of the HEAs are:

(i) The high formation entropy of HEA solids has a dominant effect on the Gibbs energy formation of an alloy phase, thus stabilizing solid solutions in relation to the bimetallic phases normally formed, (ii) The HEAs lattice structure is distorted, due to the mismatch of atomic size between allotment elements. This has a number of different effects on the physical and mechanical properties of HEAs, (iii) HEAs have smaller atomic diffusion constants because individual atoms diffusion is more difficult through solid solutions with high concentrations of many elements, mainly due to variations in the lattice structure, (iv) The complexity of HEA formulations causes a so-called ‘cocktail effect’ where interactions between elements cause unusual behavior. In the area of alloy design, we know from previous experience that adding more alloy elements usually leads to the formation of bimetallic compounds, which have poor mechanical properties.

Due to the interesting properties, for example, the high entropy phenomenon can reduce the number of phases of ingredients in an alloy and facilitate the design of the preferred micro structure. The limited diffusion effect may reduce the phase transformation rate and stabilize different microstructures at high temperatures. Significant aid may be provided by lattice distortions. And, the cocktail effect allows designing materials with custom properties by selecting the right alloy components. With appropriate alloy design and heat treatment, excellent mechanical properties such as durability, hardness, resistance to wear and corrosion are achieved.

Meanwhile, the HEAs have also attracted attention, showing interesting physical properties such as magnetic properties, electrical resistance and superconductivity. New soft magnetic materials are needed in transformers, motors, electromagnets, etc., but the poor mechanical properties of existing materials always limit their performance mainly due to the precipitation of fragile binary compounds. Recently, some high entropy alloys based on FeCoNi—X have been prepared with attractive soft magnetic properties. However, an optimal balance of mechanical and magnetic properties has not yet been found.

In assessing these claims on the basis of existing experimental data in literature, as well as the classical metallurgical understanding, it is concluded that the use of high entropy alloys (HEAs) as building blocks for the casting of new phases is one of the most promising and exciting opportunities. HEAs therefore represent one of the most exploratory and promising research areas in materials science at the moment.

### Problems Resolved with this Invention

This invention solves four key problems that coexist in the magnetic phases and the magnets that are made from them.

The first problem is economic and concerns the volatility of the price of the components needed for the manufacture of permanent magnets. The price of rare earth elements is controlled by more than 90% from China, the price of cobalt has tripled over the last three years and is expected to increase further due to increased demand for applications for lithium ion batteries, and in addition more than 50% is supplied by the Democratic Republic of Congo. Also, the price of Nd—Pr, which is a component of the best magnets at present, is now tending to increase because of the high demand of magnets for electric cars, for wind power and for a variety of other applications.

Depending on the category of magnetic phases used in the manufacture of the three groups of permanent magnets, it is possible to save up to 30-40% on the cost of rare earth elements if replaced with the appropriate HEAs based on rare earth elements (RE-HEAs) and up to 50-60% on cobalt if replaced with the corresponding HEAs based on transitional elements (TM-HEAs) with high magnetization. For alloys of the type (RE-HEAs)-(TM-HEAs), the savings that can be made on total alloy costs can reach 50% compared to those currently used.

The second problem concerns the scarcity of some rare earth elements, e.g. Dy and Tb, and therefore the possibility of replacing them with a mixture of rare earth elements that are now abundant, e.g. La or Ce, to enable the manufacture of new high entropy alloys with comparable properties to those currently used, namely samarium, neodymium praseodymium.

The third problem is that of replacing cobalt which has a magnetic moment of about 1.6 T (Tesla) with corresponding high entropy alloys based on transition metal elements such as cobalt, iron, nickel, manganese and other additives with approximately the same magnetic moment.

It is worth mentioning a fourth problem concerning the mechanical properties of permanent magnets and their fragility due to the way in which they are produced.

### Methods to Resolve these Problems

In order to solve the objects outlined above, the present invention provides in a first aspect high entropy alloys of rare earth elements (RE-HEAS) including at least four and up to twelve elements selected form rare earth elements R₁, R₂, R₃, R₄, R₅, R₆, R₇, R₈, R₉, R₁₀, R₁₁, R₁₂, which rare earth elements R₁ to R₁₂ each represents one of elements from the periodic table with atomic numbers 57 to 71 except Pm with atomic number 61 of the periodic system, including yttrium numbered 39 and zirconium numbered 40, due to their chemical affinity for rare earth elements

This first basic approach to solving the above problems is with the use for the first time of high entropy alloys based on rare earth elements with individual numbers from 57 to 71 (except Pm 61) including Yttrium numbered 39 and zirconium numbered 40, due to their chemical affinity for rare earth elements (RE-HEAs). The present RE-HEAs allow to replace especially costly or not abundantly available rare earth metals like samarium, neodymium and/or praseodymium at least partly in their current applications. In some instances it is possible to replace at least half of the amounts of such commonly used high-cost rare earth metals by more abundantly available elements, like La and Ce and thus to considerably reduce the costs involved with providing permanent magnets the demand for which is ever increasing.

Preferred examples, but not exhaustive, of inventive RE-HEAs include LaCePrNd, YLaCePrNd, YCePrNdDy, YLaCePrNdGd or LaCePrNdGdHo and optionally additional elements as defined above. However, also other combinations of rare earth elements including Zr and Y can advantageously replace current high-cost or not readily available rare earth materials. In a preferred embodiment of the invention, such rare earth elements are included in the RE-HEAs in approximately equal proportions.

In a second aspect, the invention provides high entropy alloys of transition metal elements (TM-HEAs) including at least 3 and up to 12 elements selected from transitional elements TM₁, TM₂, TM₃, TM₄, TM₅, TM₆, TM₇, TM₈, TM₉, TM₁₀, TM₁₁, TM₁₂ which transitional elements TM₁ to TM₁₂ each represent at least one of elements, with atomic numbers 21 to 30, 41 to 48 and 72 to 79 of the periodic system.

In a preferred embodiment of this aspect of the present invention, TM₁ is defined as including the three elements Fe, Co and Ni. In such embodiment, up to 9 additional elements can be included in the alloy, however, also a lower number of 3 or 5 alloy constituents is suitable when considering the envisioned application within applications like permanent magnets.

This second approach to solving the above mentioned problems is based on the replacement of all or parts of the high-cost element cobalt in respective materials within high entropy alloys based on the elements in the periodic table belonging to groups 3 to 12 with individual numbers from 21 to 30, 40 to 48 and 72 to 79 and by group 13. Optionally, also boron (5), aluminum (13), gallium (31) and indium (49) can be included as one of the at least 3 and up to 12 elements. These alloys will be hereinafter referred to as TM-HEAs.

Some especially preferred embodiments of this aspect of the invention include TM-HEAs with the compositions consisting of or comprising FeCoNi, FeCoNiMn, FeCoNiCu, FeCoNiMnAl or FeCoNiMnCuAl.

A further aspect of the present invention is the use of the RE-HEAs and/or TM-HEAs as mentioned above and throughout this specification as building blocks in magnetic high entropy composite alloys for the manufacture of magnetic devices and permanent magnets. As apparent from the foregoing and the following disclosure provided herein, in some aspects all or certain rare earth metals contained in magnetic alloys can be replaced by the RE-HEAs of the present invention and/or all or part of other elements contained in magnetic alloys can be replaced by the TM-HEAs of the present invention. Furthermore, it is also possible to combine both RE-HEAs and TM-HEAs of the present invention as a new high entropy magnetic alloy, optionally including additional materials as defined below.

Thus, another aspect of the present invention relates to high entropy composite alloys of the type

(RE-HEAs)ₓ(TM-HEAs)_{y}T_{z}

wherein
x=1, 2 y=2, 3, 5, 12, 14, 17, z=0.5-3, and

### T=Mo, Ti, V, Si, N and B

and RE-HEAs and TM-HEAs are as defined above.

When used as building blocks to replace respective parts of currently used magnetic alloys, it is preferable that the ratios of the various alloy components are maintained. Consequently, in preferred embodiments of the invention, in the high entropy composite alloys RE-HEAs are present in the same ratio as rare-earth metals in the respective alloys for which a replacement of costly or not readily available elements is desired. The same applies with regard to the TM-HEAs which also replace other elements as desired. Finally, the same applies with regard to composite alloys as stated above, in which both the hitherto used rare earth elements and other elements like cobalt are replaced by TM-HEAs.

In a further aspect, the invention provides magnetic alloys in accordance with the samarium cobalt type as described above and, especially, with stoichiometries 1:5 and 2:17. In such high entropy composite alloy of the type

SmₓCO_{y}

Sm is replaced by RE-HEAs as defined above
Co is replaced by TM-HEAs as defined above,
x=1 or 2 and
y=5, 17.

For magnets of type 1:5, the preferred new composite alloys are represented by:

Sm-(TM-HEAs)₅

(RE-HEAs)-Co₅.

More generally, also alloys of the type

(RE-HEAs)-(TM-HEAs)₅

are included within the context of the present invention.

For corresponding magnets of type 2:17 the corresponding replacements lead to alloys represented by

Sm-(TM-HEAs)_{7.5-8.5}

(RE-HEAs)-(Co_{balance}FexCu_{0.1}Zr_{0.03}) with x=0.09-0.21.

For magnets of type 2:14:1, another preferred embodiment of the invention is represented by

(RE-HEAs)₂Fe₁₄B.

For magnets type 1:12, a still further preferred embodiment of the invention is represented by

(RE-HEAs)Fe₁₂₋ₓTₓ, T=Mo, Ti, V, Si, N and x=0.5-2

As mentioned above, in these formulae for the various magnet types the above definitions apply according to which RE-HEAs=high entropy alloy based on rare earth types

R₁R₂R₃R₄ . . . R₁₂

R=rare earth elements of La, Ce, Pr, Nd, Sm, Eu, Gd, Tb, Dy, Ho, Er, Tm, Yb and Y, Zr and

TM-HEAs=high entropy alloy based on type transition elements (TMs)

TM₁TM₂TM₃TM₄ . . . TM₁₂

with preferably TM₁=(Fe,Co,Ni)
and TM₂TM₃TM₄ . . . TM₁₂ selected from other transitional elements plus B, Al, Ga and In.

For the manufacture of the above alloys (RE-HEAs), (TM-HEAs) and the preparation of magnetic phases based thereon as described in detail above and also for the manufacture of alloys of the type

(RE-HEAs)-(TM-HEAs)

which are the raw materials for the manufacture of permanent magnets, the manufacturing techniques are conventional techniques for the manufacture of alloys, especially
a) arc-melting or
b) RF melting
powders from the recommended materials and with a solid state reaction (reaction) either in an electric resistance oven or in a microwave oven.

Conventional crystallography techniques, Curie point measurement and magnetic hysteresis loop are used to characterize the alloys above, as well as a change in magnetization with temperature.

It is noteworthy that casting (RE-HEAs) without any impediment leads to phases mainly with a hexagonal structure in most cases.

Also noteworthy is the fact that casting (TM-HEAs), without any annealing leads to phases with cubic symmetry either FCC or BCC characteristic of high entropy alloys.

The most important achievement of this invention is that while the normal magnetic phases used to date for the manufacture of magnets require after casting time-consuming and complex thermal treatment, using high-entropy alloys, it is usually and preferably not necessary to anneal magnetic phases after casting.

Due to the exceptional anti-corrosive properties of high entropy alloys (RE-HEAs) and (TM-HEAs), they remain unoxidized for a long time compared to the components of rare earth elements that are rapidly oxidized with air exposure.

Also due to exceptional mechanical properties of (RE-HEAs) and (TTM-HEAs) and that slow diffusion leads to a different micro structure, potentially desirable for the development of a large coercive field, this invention covers the possibility of casting rather than sintering magnets.

The main advantage of this invention is also to achieve large savings in the cost of raw materials for the manufacture of magnets.

### FIGURE DESCRIPTION

The above and other features of this invention, nature and various advantages, are presented in conjunction with the schemes that accompany it.

FIG. 1 shows the hysteresis loop of a magnetic material, showing the parameters that are of interest for applications. Point 10 is the saturation magnetization of the material; point 20 is the residual magnetization and point 30 is the coercive field. The area of the hysteresis loop is proportional to the energy product of the material.

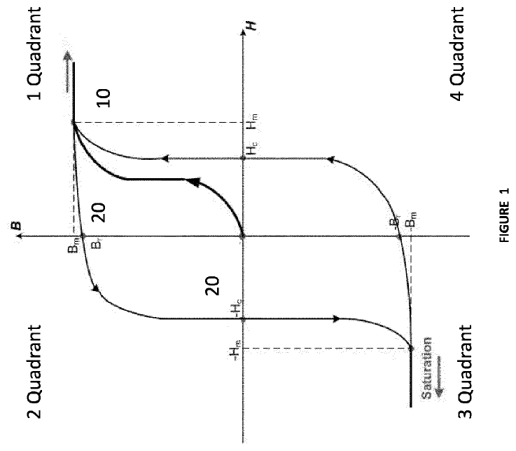

FIG. 2 shows the structure of the SmCo5 material by replacing the samarium with the equivalent (RE-HEAs) and replacing the cobalt with the corresponding (TM-HEAs). 10 is one (RE-HEAs) and 20 is one (TM-HEAs).

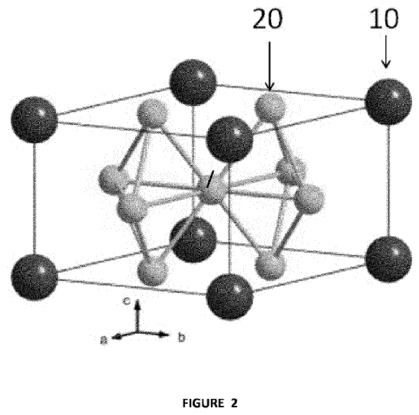

FIG. 3 shows the structure of an alloy with five elements of the periodic system and the small deformation of the lattice due to the difference in individual atomic radii. 10 could be TM₁, 20 TM₂, 30 TM₃, 40 TM₄ and 50 TM₅, as stated in the text on TM-HEAs. It could also be 10 to R₁, 20 to R₂, 30 to R₃, 40 to R₄ and 50 to R₅ in the case of RE-HEAs.

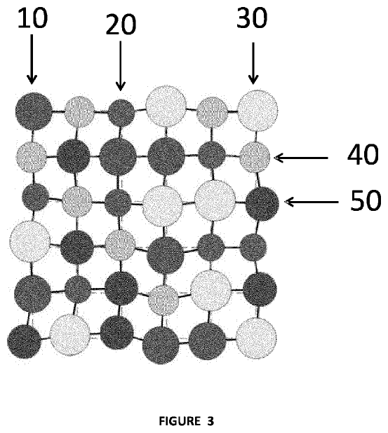

### EXAMPLES

### Example 1: Type Phase 1:5 SmCo5

At this stage it is possible to replace either rare earth Sm with (RE-HEAs), or cobalt with equivalent (TM-HEAs) or rare earth and cobalt simultaneously and on production of

(RE-HEAs)(TM-HEAs))₅.

(RE-HEAs) means rare earth alloys with at least four and up to 12 elements in approximately equal proportions, e.g. with four LaCePrNd elements, five YLaCePrNd elements, or six LaCePrNdGdHo elements, etc.

These alloys are prepared by mixing rare earth metals of a purity of at least 99.9 at % and by melting by techniques such as arc melting, or with high-frequency currents in an inert atmosphere e.g. to avoid any oxidation. In addition to rare earth elements yttrium and zirconium can be used as elements too.

(TM-HEAs) define alloys with at least three and up to 12 elements in approximately equiatomic proportions and based on the three magnetic materials at room temperature from the periodic table such as iron, cobalt and nickel, e.g. with three FeCoNi components, four FeCoNiMn components, five FeCoNiMnAl components, six FeCoNiMnCuAl components, etc.

These alloys are prepared by mixing transition metals from the periodic table of at least 99.9 at % and by melting by techniques such as arc melting, or high-frequency currents in an inert atmosphere e.g. to avoid oxidation. In addition to the transition elements, elements such as boron, aluminum, gallium and indium can be used.

Magnetic phases leading to appropriate type processing (RE-HEAs)(TM-HEAs)₅ are made by selecting the corresponding (RE-HEAs) with the desired (TM-HEAs) in the 1:5 ratio and using the same techniques as described for the manufacture of RE-HEAs and TM-HEAs. No further processing is required and phase 1:5 is formed with very good properties.

Such a phase is (Y,Ce,Pr,Nd,Dy)Co₅ with a magnetization of ˜75 emu/g, magnetocrystalline anisotropy field ˜12 T, Curie point >500° C. and a theoretical energy product of 80-130 KJ/m³.

A corresponding phase is Sm—(Fe,Co,Ni,Cu)₅ with a theoretical energy product of the order of 70-100 KJ/m³, but with a material cost much lower, as cobalt present in the structure is ⅕ compared to SmCo5. There are too many combinations, but in category 1:5 it is the cobalt replacement that can bring the greatest economic benefits. Greater benefits are in the Sm(Cobalt (balance)FeₓCu_{0.1}Zr_{0.03})_{7.5-5.5} series (x=0.09-0.21) as the Co/Sm ratio is even greater.

### Example 2: Type Phase Nd2Fei4B

At this stage savings are only achieved by replacing the expensive neodymium (or Nd—Pr, as, in industry, neodymium-praseodymium alloy is used) with RE-HEAs which are both more abundant and cheaper, such as (Y,La,Ce,Nd—Pr,Gd,Ho, . . . ). It is not in any way in the interests of replacing iron which the more abundant and economic material in nature. If the alloy (Y,La,Ce,Pr,Nd)₂Fe₁₄B is produced, it has slightly inferior magnetic properties as Nd2Fei4B, but at a lower cost of 45% and for the alloy (Y,La,Ce,Pr,Nd,Gd)₂Fe₁₄B the savings can reach 40%. This phase has a magnetization of about 1000 emu/g, Curie point around 300° C. and an anisotropy of 20% less than the initial phase Nd₂Fe₁₄B. We can achieve an energy product in the range 30-40 MGOe (240-320 KJ/m³).

### Example 3: Type Phase NdFe₁₂₋ₓTiₓ

At this stage savings are only achieved by replacing the expensive neodymium (in industry, neodymium-praseodymium alloy is used) with RE-HEAs which are both more abundant and cheaper, such as (Y,La,Ce,Nd—Pr,Gd, Ho, . . . ). It is not in any way in the interests of replacing iron, which is the most abundant and economic material in nature. For the alloy (Y,La,Ce,Pr,Nd)Fe₁₂₋ₓTiₓ almost the same magnetic properties as NdFe₁₂₋ₓTiₓ and twice the anisotropy field are obtained, but at a cost of 45% and for the alloy (Y,La,Ce, Pr,Nd, Gd)Fe₁₂₋ₓTiₓ savings may be as high as 40%.

There are too many combinations that highlight the value of using high entropy alloys either on the basis of rare earth elements or the transition metal elements or the combination of both in the above magnetic compounds, which by itself and by a more simpler process than has been the case to date for the manufacture of permanent magnets. This invention not only results in the saving of material and resources but also because of the properties of high entropy alloys leads to fewer stages in the preparation of alloys, but also because of mechanical properties in the production capacity of permanent magnets by casting and because of low diffusion, we can manipulate the microstructure to achieve desirable coercivity necessary for the fabrication of permanent magnets. Also, the materials of the present invention can be cast in any shape and under suitable microstructure conditions to be permanent magnets with highly desirable properties.

High entropy alloys of rare earths and transition metals as building blocks for novel magnetic phases for permanent magnets:

The technical field referred to in the invention is that of simple and complex high-entropy magnetic alloys based on the periodic table of chemical elements with excellent magnetic and mechanical properties as new building blocks for the replacement of rare earths and cobalt in magnetic phases and in the technical field of permanent magnets prepared therewith.

The high cost and limitation on the supply of raw materials, such as rare earths and cobalt, which are the main ingredients in magnetic alloys for the manufacture of high quality permanent magnets, are successfully dealt with the creation of high entropy alloys based on rare earths and transition elements, which also offer better mechanical properties. With this approach we achieve a cost reduction of raw materials of over 40% without greatly altering the magnetic properties of the new phases and with better mechanical properties for better permanent magnets.

1. High entropy alloy of rare earth elements (RE-HEAs) including at least four and up to twelve elements selected form rare earth elements R₁, R₂, R₃, R₄, R₅, R₆, R₇, R₈, R₉, R₁₀, R₁₁, R₁₂, which rare earth elements R₁ to R₁₂ each represents one of elements 57 to 60, 62 to 70, 39 and 40 of the periodic system.

2. RE-HEAs according to claim 1, wherein the at least four to up to twelve rare earth elements are present in approximately equal proportions.

3. RE-HEAs according to claim 1, wherein the alloy includes at least one member selected from the group consisting of LaCePrNd, YLaCePrNd, YCePrNdDy, YLaCePrNdGd and LaCePrNdGdHo.

4. High entropy alloy of transition elements (TM-HEAs) including at least 3 and up to 12 elements selected from transitional elements TM₁, TM₂, TM₃, TM₄, TM₅, TM₆, TM₇, TM₈, TM₉, TM₁₀, TM₁₁, TM₁₂, which transitional elements TM₁ to TM₁₂ each represent at least one of elements 21 to 30, 41 to 48 and 72 to 79 of the periodic system.

5. TM-HEAs according to claim 4, wherein TM₁ comprises the three elements Fe, Co and Ni.

6. TM-HEAs according to claim 4, further comprising at least one member selected from the group consisting of B, Al, Ga and In.

7. TM-HEAs according to claim 4, comprising at least one member selected from the group consisting of FeCoNi, FeCoNiMn, FeCoNiCu, FeCoNiMnAl and FeCoNiMnCuAl.

8. A magnetic high entropy composite alloy for the manufacture of magnetic devices and permanent magnets comprising the Use of RE-HEAs according to claim 1.

9. High entropy composite alloy of the formula
(RE-HEAs)ₓ(TM-HEAs)_{y}T_{z}
wherein
x=1, 2 y=2, 3, 5, 12, 14, 17, z=0.5-3, and
T=Mo, Ti, V, Si, N and B,
and the RE-HEAs of claim 1 and a high entropy alloy of transition elements (TM-HEAs) including at least 3 and up to 12 elements selected from transitional elements TM₁, TM₂, TM₃, TM₄, TM₅, TM₆, TM₇, TM₈, TM₉, TM₁₀, TM₁₁, TM₁₂, which transitional elements TM₁ to TM₁₂ each represent at least one of elements 21 to 30, 41 to 48 and 72 to 79 of the periodic system.

10. High entropy composite alloy of the formula
SmₓCO_{y}
wherein
Sm is replaced by RE-HEAs as defined in claim 1 and/or
Co is replaced by a high entropy alloy of transition elements (TM-HEAs) including at least 3 and up to 12 elements selected from transitional elements TM₁, TM₂, TM₃, TM₄, TM₅, TM₆, TM₇, TM₈, TM₉, TM₁₀, TM₁₁, TM₁₂, which transitional elements TM₁ to TM₁₂ each represent at least one of elements 21 to 30, 41 to 48 and 72 to 79 of the periodic system,
x=1 or 2 and
y=5, 17.

11. High entropy composite alloy of the formula
(RE-HEAs)₂Fe₁₄B
wherein (RE-HEAs) is defined as in claim 1.

12. High entropy composite alloy of the formula
((RE-HEAs)Fe₁₂₋ₓTₓ,
wherein the RE-HEAs is the RE-HEAs of claim 1,
T=Mo, Ti, V, Si, N, and
x=0.5-2.

13. Method of manufacture of high entropy alloys according to claim 1 comprising mixing powders comprising the elements of RE-HEAs and/or the elements of TM-REAs, melting the powders and casting the alloys into appropriate shape.

14. Method according to claim 13, in which melting is achieved via arc-melting or RF-melting in an electric resistance over or a microwave oven, preferably in an inert atmosphere.

15. A permanent magnet comprising a high entropy composite alloy according to claim 9.

16. A magnetic high entropy composite alloys for the manufacture of magnetic devices and permanent magnets comprising the RE-HEAs according to claim 4.

17. Method of manufacture of high entropy composite alloys according to claim 9 comprising mixing powders comprising the elements of RE-HEAs and/or the elements of TM-REAs, melting the powders and casting the alloys into appropriate shape.

18. High entropy composite alloy of the formula
((RE-HEAs)Fe₁₂₋ₓTₓ,
wherein the RE-HEAs comprise the RE-HEAs of claim 2,
T=Mo, Ti, V, Si, N, and
x=0.5-2.

19. High entropy composite alloy of the formula
((RE-HEAs)Fe₁₂₋ₓTₓ,
wherein the RE-HEAs comprise the RE-HEAs of claim 3,
T=Mo, Ti, V, Si, N, and
x=0.5-2.

20. Method of manufacture of high entropy alloys according to claim 2 comprising mixing powders comprising the elements of RE-HEAs and/or the elements of TM-REAs, melting the powders and casting the alloys into appropriate shape.
